(19) United States
(12) Patent Application Publication
(10) Pub. No.: US 2025/0154983 A1
(43) Pub. Date: May 15, 2025

(54) CONTROL SYSTEM FOR A MAGNETIC BEARING AND ASSOCIATED CONTROL METHOD

(71) Applicant: SKF Magnetic Mechatronics, Saint-Marcel (FR)

(72) Inventors: Lakdar SADI-HADDAD, Nogent sur Marne (FR); Josue SAURY, Saint-Marcel (FR)

(21) Appl. No.: 18/938,408

(22) Filed: Nov. 6, 2024

(30) Foreign Application Priority Data
Nov. 14, 2023 (FR) 2312415

(51) Int. Cl. F16C 32/04

(52) U.S. Cl. CPC F16C 32/0451

(57) ABSTRACT

A control system (1) for a magnetic bearing (2) includes a first control branch (BR1) and a second control branch (BR2). The first control branch (BR1) includes at least one control means (3) configured to drive at least one first servo control shaft of the magnetic bearing. The second control branch (BR2) is identical to the first control branch (BR1). The control system (1) may also include a selection means (5) for activating the control means (4) of the second control branch (BR2) upon the failure of the control means (3) of the first control branch (BR1).

### CROSS-REFERENCE TO RELATED APPLICATION

This application claims priority to French Application No. 2312415, filed Nov. 14, 2023, the entirety of which is hereby incorporated by reference.

### FIELD

The present disclosure relates to the control of magnetic bearings.

The present disclosure relates more particularly to a control system for a magnetic bearing and to a method for controlling the control system.

### BACKGROUND

Conventionally, a magnetic-bearing control system is based on a centralized or distributed architecture.

A centralized magnetic-bearing control system comprises at least one position control node implementing an algorithm for servo controlling the position of a rotor in the magnetic bearing, and amplification nodes driving the servo control shafts of the magnetic bearing on the basis of information generated by the servo control algorithm of the control node.

In a distributed magnetic-bearing control system, some or all of the tasks executed by the position control node are executed by shaft control nodes. This distribution of tasks makes it possible to apportion the computing power over all of the elements constituting the system and to be more flexible with regard to the number of shafts to be managed by the magnetic-bearing control system.

However, failure of one node in one or the other of the architectures compromises the proper functioning of the magnetic-bearing control system such that the servo control shaft of the magnetic bearing driven by said faulty node is no longer driven, compromising the proper functioning of the magnetic-bearing control system and leading to the failure of the magnetic bearing.

It is therefore proposed to overcome all or some of these drawbacks by improving the availability of the magnetic-bearing control system, the control system being of centralized type or of distributed type.

### SUMMARY

In light of the above, the present disclosure proposes a control system for a magnetic bearing, comprising a first control branch including at least one control means configured to drive at least one first servo control shaft of the magnetic bearing.

“Servo control shaft of the bearing” is understood to mean the shaft which is defined by two diametrically opposite coils of the stator of the magnetic bearing.

The control system furthermore includes a second control branch identical to the first control branch, and selection means configured to activate the control means of the second control branch upon the failure of the control means of the first control branch such that the activated control means of the second branch drives the first servo control shaft or configured to activate the control means of the second control branch upon receiving a signal to activate the second control branch such that the control means of the first and second branches drive the first servo control shaft.

Substituting the faulty control means of the first branch with the control means of the second branch connected to the same servo control shaft when the control means of the first branch is faulty (passive or “cold” substitution) allows the bearing to be continued to be driven.

Activating the control means of the second control branch by way of the selection means upon receiving a signal to activate the second control branch makes it possible to drive the first servo control shaft simultaneously so as to inject more power for driving said shaft during transient phases and to obtain active or “hot” redundancy such that the control of said shaft is not interrupted, unlike passive redundancy which requires an instant of switching of the control means.

Advantageously, the control means of the first branch comprises a first shaft control node configured to drive the first servo control shaft, and the control means of the second branch comprises a first shaft control node configured to drive the first servo control shaft, the first shaft control node of the first branch and the first shaft control node of the second branch being connected to the selection means.

Preferably, the control means of the first branch comprises at least one second shaft control node configured to drive a second servo control shaft, and the control means of the second branch comprises at least one second shaft control node configured to drive the second servo control shaft, the shaft control nodes of the first branch being connected to one another in series such that the second node of the first branch is connected to the first node of the first branch, and the shaft control nodes of the second branch being connected to one another in series such that the second node of the second branch is connected to the first node of the second branch.

Advantageously, that node from amongst the shaft control nodes of the first branch which is connected only to a single shaft control node of the first branch is connected to the corresponding shaft control node of the second branch.

Preferably, the control means of the first branch comprises a second shaft control node configured to drive a second servo control shaft, and the control means of the second branch comprises a second shaft control node configured to drive the second servo control shaft, the second control node of the first branch and the second control node of the second branch being connected to the selection means.

Advantageously, the control means of the first branch comprises a position control node and a first amplification node which are configured to drive the first servo control shaft, and the control means of the second branch comprises a position control node and a first amplification node which are configured to drive the first servo control shaft, the first amplification node of the first branch being connected to the position control node of the first branch and the first amplification node of the second branch being connected to the position control node of the second branch, the position control node of the first branch and the position control node of the second branch being connected to the selection means.

Preferably, the first branch comprises at least one second amplification node configured to drive a second servo control shaft, and the second branch comprises at least one second amplification node configured to drive the second servo control shaft, the amplification nodes of the first branch being connected to one another in series and the amplification nodes of the second branch being connected to one another in series.

Advantageously, that amplification node of the first branch which is connected only to a single amplification node of the first branch is furthermore connected to the position control node of the first branch, and that amplification node of the second branch which is connected only to a single amplification node of the second branch is furthermore connected to the position control node of the second branch.

Preferably, that amplification node of the first branch which is connected only to a single amplification node of the first branch is furthermore connected to the corresponding amplification node of the second branch.

Also proposed is a method for controlling a control system for a magnetic bearing, the system comprising a first control branch including at least one control means driving at least one first servo control shaft of the magnetic bearing, and a second control branch identical to the first control branch.

The method comprises:
activating the control means of the second control branch upon the failure of the control means of the first control branch such that the activated control means of the second branch drives the first servo control shaft or
activating the control means of the second control branch upon receiving a signal to activate the second control branch such that the first and second branches drive the first servo control shaft.

### BRIEF DESCRIPTION OF THE DRAWINGS

Further aims, features and advantages of the present disclosure will become apparent from reading the following description, which is given purely by way of nonlimiting example and with reference to the appended drawings, in which:

FIG. 1 illustrates an example of a control system for a magnetic bearing according to the present disclosure;

FIG. 2 illustrates a first exemplary embodiment of the control system according to the present disclosure;

FIG. 3 illustrates a second exemplary embodiment of the control system according to the present disclosure;

FIG. 4 illustrates a third exemplary embodiment of the control system according to the present disclosure;

FIG. 5 illustrates a fourth exemplary embodiment of the control system according to the present disclosure;

FIG. 6 illustrates a fifth exemplary embodiment of the control system according to the present disclosure; and

FIG. 7 illustrates a sixth exemplary embodiment of the control system according to the present disclosure.

### DETAILED DESCRIPTION

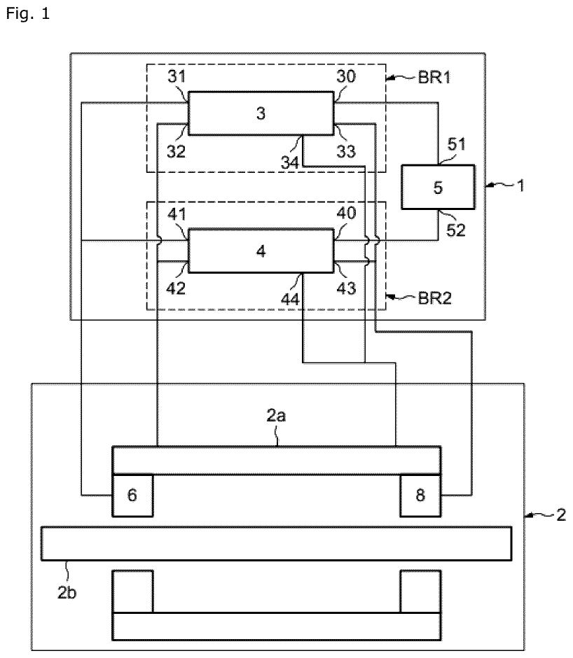

Reference is made to FIG. 1 which illustrates an example of a control system 1 for a magnetic bearing, driving a magnetic bearing 2.

In a manner known per se, the magnetic bearing 2 comprises a stator 2a and a rotor 2b placed in the stator 2a.

The stator 2a comprises stator coils distributed uniformly in the circumferential direction on the internal side of the stator 2a, two diametrically opposite coils supplied with power by electric power converters.

Two diametrically opposite stator coils define a servo control shaft of the magnetic bearing and make it possible to drive this shaft.

The control system 1 comprises a first control branch BR1 and a second control branch BR2 identical to the first control branch BR1.

Each control branch BR1, BR2 comprises a control means 3, 4.

The control system 1 furthermore comprises selection means 5 comprising a first control output 51 connected to a first control input 30 of the control means 3 of the first branch BR1 and a second control output 52 connected to a first control input 40 of the control means 4 of the second branch BR2.

The control means 3, 4 of each control branch BR1, BR2 furthermore comprises a second input 31, 41 connected to a first sensor 6, and a first control output 32, 42 supplying power to the stator coils in order to drive a first servo control shaft of the magnetic bearing 2.

The control means 3, 4 of each control branch BR1, BR2 furthermore comprises a third input 33, 43 connected to a second sensor 8, and a second control output 34, 44 supplying power to the stator coils in order to drive a second servo control shaft of the magnetic bearing 2.

Each first control output 32, 42 supplies power to the first servo control shaft of the magnetic bearing comprising two opposite stator coils (not shown) of the bearing 2 and each second control output 34, 44 supplies power to the second servo control shaft of the magnetic bearing comprising two opposite stator coils (not shown) of the bearing 2, the stator coils generating a magnetic flux in order to keep the rotor 2b of the bearing levitating in the stator 2a.

The sensors 6, 8 measure for example radial or axial movements of the rotor 2b, the angular position of the rotor 2b, and transmit the measured data to the control means 3, 4 of each branch BR1, BR2.

The control system 1 drives two servo control shafts of the bearing 2.

The control means 3, 4 of each control branch BR1, BR2 is intended to drive the two servo control shafts of the bearing 2.

The selection means 5 are able to activate the control means 4 of the second control branch BR2 upon the failure of the control means 3 of the first control branch BR1 such that the activated control means 4 of the second branch BR2 drives at least one of the first and second servo control shafts.

Substituting the faulty control means of the first branch with the control means of the second branch connected to the same servo control shaft when the control means of the first branch is faulty (passive or “cold” substitution) allows the bearing to be continued to be driven.

The selection means 5 are furthermore able to activate the control means 4 of the second control branch BR2 upon receiving a signal to activate the second control branch such that the control means 3, 4 of the first and second branches BR1, BR2 drive at least one of the first and second servo control shafts.

Activating the control means of the second control branch by way of the selection means upon receiving a signal to activate the second control branch makes it possible to drive the first servo control shaft simultaneously so as to inject more power for driving said shaft during transient phases and to obtain active or “hot” redundancy such that the control of said shaft is not interrupted, unlike passive redundancy which requires an instant of switching of the control means.

Of course, the control system 1 may drive more than two servo control shafts of the bearing 2, the control means 3, 4 of each control branch BR1, BR2 being able to drive said shafts.

As a variant, the control system 1 may drive a single servo control shaft of the bearing 2, the control means 3, 4 of each control branch BR1, BR2 being able to drive said shaft.

A number of exemplary embodiments of the first and second control branches BR1, BR2 are now described.

In the exemplary embodiments of the first and second control branches BR1, BR2 described below, the means 3, 4 comprise shaft control nodes, the architecture of the control system 1 being of the decentralized type.

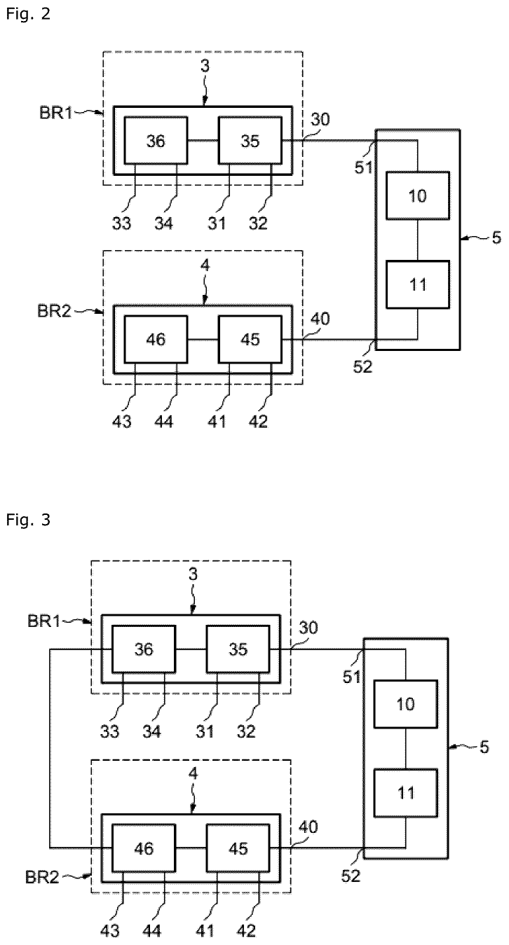

FIG. 2 illustrates a first exemplary embodiment of the first and second control branches BR1, BR2.

The control means 3, 4 of the first and second branches BR1, BR2 comprises a first shaft control node 35, 45 and a second shaft control node 36, 46.

Each control node 35, 36, 45, 46 implements an algorithm for driving a servo control shaft of the magnetic bearing 2, determined in particular on the basis of the measurements from the sensors 6, 8.

Each branch BR1, BR2 comprises as many control nodes as there are servo control shafts of the bearing 2, for each branch, each control node driving one servo control shaft of the bearing 2.

A first control node 35 of the control means 3 of the first branch BR1 is connected to the first control input 30 of the control means 3 of the first branch BR1, to the second input 31 and to the first output 32 of said control means 3.

The second node 36 of the control means 3 of the first branch BR1 is connected to the third input 33 and to the second control output 34 of said control means 3.

The first and second control nodes 35, 36 of the control means 3 of the first branch BR1 are furthermore connected to one another in series, for example by a data bus.

A first control node 45 of the control means 4 of the second branch BR2 is connected to the first control input 40 of the control means 4 of the second branch BR2, to the second input 41, and to the first output 42 of said control means 4.

The second node 46 of the control means 4 of the second branch BR2 is connected to the third input 43 and to the second control output 44 of said control means 4.

The first and second control nodes 45, 46 of the control means 4 of the second branch BR2 are furthermore connected to one another in series, for example by a data bus.

The first nodes 35, 45 of the first and second branches BR1, BR2 are able to control the first servo control shaft, and the second nodes 36, 46 of the first and second branches BR1, BR2 are able to control the second servo control shaft.

When the bearing 2 comprises more than two servo control shafts, the additional shaft control nodes of each branch BR1, BR2 are connected to one another in series to the second node 36, 46 such that the second node 36, 46 of each branch BR1, BR2 is connected to the first node 35, 45 of said branch.

When the bearing 2 comprises a single servo control shaft, each branch BR1, BR2 comprises a single shaft control node.

The selection means 5 comprise for example a first master control node 10 and a second master control node 11 that are connected in series.

The first master control node 10 is furthermore connected to the first control output 51, and the second master control node 11 is furthermore connected to the second control output 52.

As a variant, the selection means 5 comprise a single master control node connected to the first control output 51 and to the second control output 52.

FIG. 3 illustrates a second exemplary embodiment of the first and second control branches BR1, BR2.

The control nodes 35, 36, 45, 46 and the master control nodes 10, 11 are shown arranged as described above.

This exemplary embodiment of the first and second control branches BR1, BR2 differs from the first exemplary embodiment illustrated in FIG. 2 in that that node from amongst the shaft control nodes 35, 36 of the first branch BR1 which is connected only to a single shaft control node of the first branch BR1 is connected to the corresponding shaft control node of the second branch.

In the present case, since the first control node 35, 45 of each means 3, 4 is connected to the second node 36, 46 of said means 3, 4 and to the selection means 5, the second node 36, 46 of each means 3, 4 is connected to the single shaft control node of said means 3, 4.

The second nodes 36, 46 of the means 3, 4 are connected to one another, for example by a bus.

This additional connection allows communication between the first and second branches BR1, BR2 when the selection means 5 are faulty or when one of the first nodes 35, 45 is faulty.

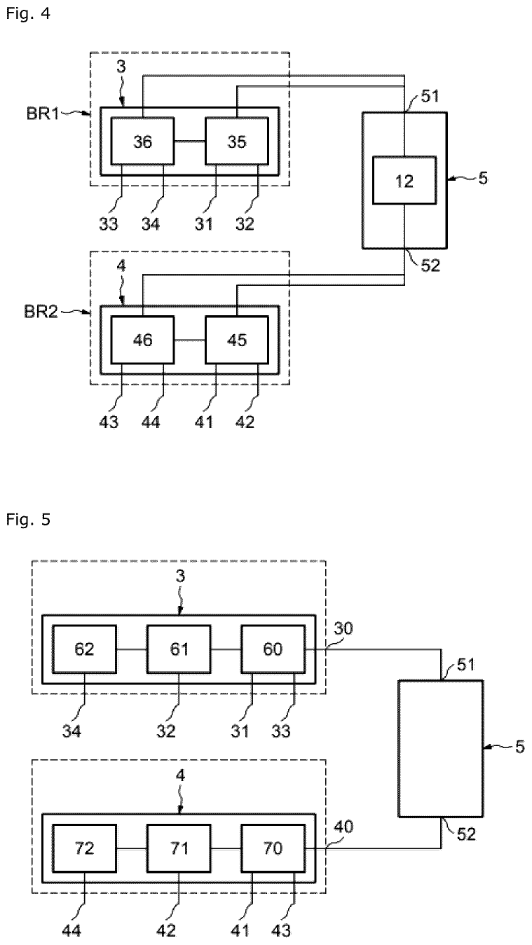

FIG. 4 illustrates a third exemplary embodiment of the first and second control branches BR1, BR2.

The control nodes 35, 36, 45, 46 and the selection means 5 are shown.

The first and second control nodes 35, 36 of the means 3 of the first branch BR1 are each connected to the first control output 51 of the selection means 5, and the first and second control nodes 45, 46 of the means 4 of the second branch BR2 are each connected to the second control output 52 of the selection means 5.

The selection means 5 comprise for example a single master control node 12 connected to the first and second control outputs 51, 52 of the selection means.

In this architecture, each node 35, 36, 45, 46 is directly connected to the selection means 5 such that if one of the nodes 35, 36, 45, 46 of a branch BR1, BR2 is faulty, the functioning nodes continue to communicate with the selection means.

Now, modes of implementation of the above-described embodiments of the branches BR1 and BR2 of the system 1 are described.

It is assumed that the bearing 2 is driven by the nodes of the first branch BR1, the nodes of the second branch BR2 being deactivated.

When the selection means 5 detect the failure of one of the shaft control nodes 36, 35 of the first branch BR1, said means 5 activate the corresponding node of the second branch BR2 such that the bearing 2 continues to function when the associated node is activated.

As a variant, when the selection means 5 detect the failure of one of the shaft control nodes 36, 35 of the first branch BR1, said means 5 deactivate all of the nodes of the first branch BR1 and activate all of the nodes of the second branch BR2 such that the bearing 2 continues to function when the nodes of the second branch BR2 are activated.

According to another mode of implementation, when the selection means 5 receive a signal to activate the second control branch BR2, the selection means 5 activate the nodes of the second branch BR2 such that the nodes of the first and of the second branch BR1, BR2 drive the bearing 2.

The activation signal is for example emitted by a master control controller of the bearing 2 (not shown) connected to the selection means 5 by a bus (not shown).

In the exemplary embodiments of the first and second control branches BR1, BR2 described above, the means 3, 4 comprise shaft control nodes.

In the exemplary embodiments of the first and second control branches BR1, BR2 described below, the means 3, 4 comprise position control nodes and amplification nodes, the architecture of the control system 1 being of centralized type.

FIG. 5 illustrates a fourth exemplary embodiment of the first and second control branches BR1, BR2.

The control means 3, 4 of the first and second branches BR1, BR2 comprises a position control node 60, 70, a first amplification node 61, 71 and a second amplification node 62, 72.

Each branch BR1, BR2 comprises as many amplification nodes as there are servo control shafts of the bearing 2, for each branch, each amplification node driving one servo control shaft of the bearing 2.

The position control node 60 of the control means 3 of the first branch BR1 is connected to the first control input 30 of the control means 3 of the first branch BR1, to the second input 31 of the first branch BR1 and to the third input 33 of the first branch BR1.

The position control node 60, the first amplification node 61 and the second amplification node 62 of the means 3 of the first branch BR1 are connected to one another in series.

The first amplification node 61 is connected to the position control node 60 and to the second amplification node 62.

The first amplification node 61 is furthermore connected to the first output 32 of said control means 3.

The second amplification node 62 is furthermore connected to the second output 34 of said control means 3.

The position control node 70 of the control means 4 of the second branch BR2 is connected to the first control input 40 of the control means 4 of the second branch BR2, to the second input 41 of the second branch BR2 and to the third input 43 of the second branch BR2.

The position control node 70, the first amplification node 71 and the second amplification node 72 of the means 4 of the second branch BR2 are connected to one another in series.

The first amplification node 71 is connected to the position control node 70 and to the second amplification node 72.

The first amplification node 71 is furthermore connected to the first output 42 of said control means 4.

The second amplification node 72 is furthermore connected to the second output 44 of said control means 4.

Each position control node 60, 70 is able to implement an algorithm for driving a servo control shaft of the magnetic bearing 2 in order to determine and transmit driving instructions to the amplification nodes 61, 62, 71, 72 which are connected to said position control node 60, 70, on the basis in particular of the measurements from the sensors 6, 8.

When the bearing 2 comprises more than two servo control shafts, the additional amplification nodes of each branch BR1, BR2 are connected to one another in series to the second amplification node 62, 72 such that the first amplification node 61, 71 of each branch BR1, BR2 is connected to the position control node 60, 70 of said branch.

When the bearing 2 comprises a single servo control shaft, each branch BR1, BR2 comprises the position control node and a single amplification node connected to said control node.

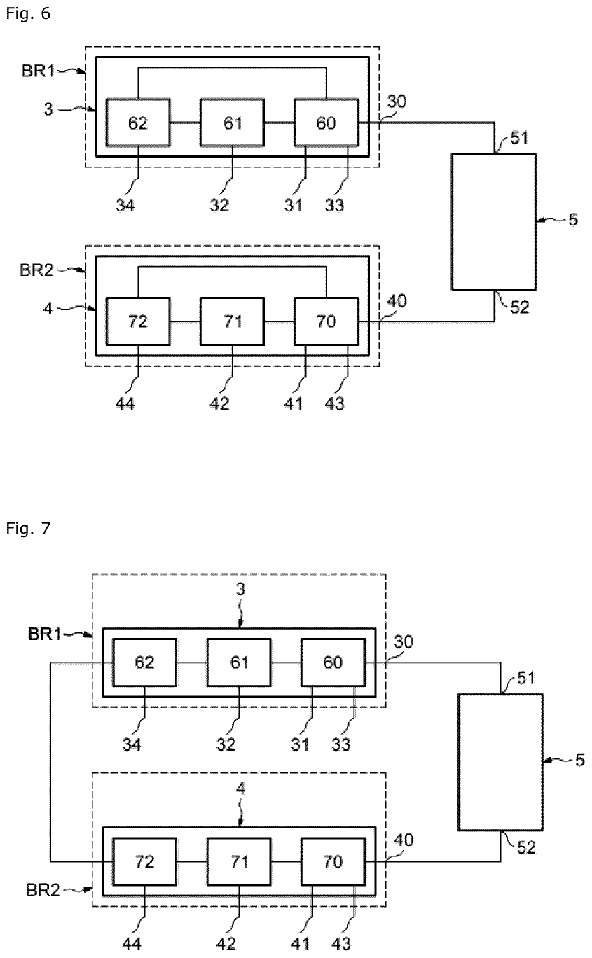

FIG. 6 illustrates a fifth exemplary embodiment of the first and second control branches BR1, BR2.

The position control nodes 60, 70 and the amplification nodes 61, 62, 71, 72 are shown arranged as described above in the fourth exemplary embodiment in FIG. 5.

This exemplary embodiment of the first and second control branches BR1, BR2 differs from the fourth exemplary embodiment illustrated in FIG. 5 in that that amplification node of the first branch BR1 which is connected only to a single amplification node of the first branch BR1 is furthermore connected to the position control node 60 of the first branch BR1, and that amplification node of the second branch BR2 which is connected only to a single amplification node of the second branch BR2 is furthermore connected to the position control node 70 of the second branch BR2.

In the present case, since the first amplification node 61, 71 of each means 3, 4 is connected to the position control node 60, 70 of said means 3, 4 and to the second amplification node 62, 72 of said means 3, 4, the second amplification node 62, 72 of each means 3, 4 is connected only to a single amplification node of said means 3, 4.

The second amplification node 62 of the first branch BR1 is connected to the position control node 60 of the first branch BR1, and the second amplification node 72 of the second branch BR2 is connected to the position control node 70 of the second branch BR2.

This additional connection allows the position control node 60, 70 of a branch BR1, BR2 to transmit instructions to all of the amplification nodes 61, 62, 71, 72 of said branch redundantly by way of the first and last amplification nodes of said branch such that if a node located between the first and last nodes is faulty or a connection, for example a bus, connecting one of the nodes located between the first and last amplification nodes is faulty, the functioning nodes of said branch BR1, BR2 continue to receive the instructions from the position control node 60, 70 of said branch.

FIG. 7 illustrates a sixth exemplary embodiment of the first and second control branches BR1, BR2.

The position control nodes 60, 70 and the amplification nodes 61, 62, 71, 72 are shown arranged as described above in the fourth exemplary embodiment in FIG. 5.

This exemplary embodiment of the first and second control branches BR1, BR2 differs from the fourth exemplary embodiment illustrated in FIG. 5 in that that amplification node from amongst the amplification nodes 61, 62 of the first branch BR1 which is connected only to a single amplification node of the first branch BR1 is connected to the corresponding shaft control node of the second branch BR2.

In the present case, since the first amplification node 61, 71 of each means 3, 4 is connected to the second amplification node 62, 72 of said means 3, 4 and to the position control node 60, 70 of said branch BR1, BR2, the second amplification node 62, 72 of each means 3, 4 is connected only to a single amplification node of said means 3, 4.

The second amplification nodes 62, 72 of the means 3, 4 are connected to one another, for example by a bus.

This additional connection allows communication between the first and second branches BR1, BR2 when the selection means 5 are faulty or when one of the first amplification nodes 61, 71 is faulty.

Now, modes of implementation of the embodiments of the branches BR1 and BR2 of the system 1 according to the exemplary embodiments described in FIGS. 5, 6 and 7 are described.

It is assumed that the bearing 2 is driven by the nodes of the first branch BR1, the nodes of the second branch BR2 being deactivated.

When the selection means 5 detect the failure of one node from amongst the position control node and the amplification nodes of the first branch BR1, said means 5 activate the corresponding node of the second branch BR2 such that the bearing 2 continues to function when the associated node is activated.

As a variant, when the selection means 5 detect the failure of one node from amongst the position control node and the amplification nodes of the first branch BR1, said means 5 deactivate all of the nodes of the first branch BR1 and activate all of the nodes of the second branch BR2 such that the bearing 2 continues to function when the nodes of the second branch BR2 are activated.

According to another mode of implementation, when the selection means 5 receive a signal to activate the second control branch BR2, the selection means 5 activate the nodes of the second branch BR2 such that the nodes of the first and of the second branch BR1, BR2 drive the bearing 2.

What is claimed is:

1. A control system for a magnetic bearing, the control system comprising:
a first control branch including at least one control means configured to drive at least one first servo control shaft of the magnetic bearing;
a second control branch identical to the first control branch; and
selection means configured to activate the control means of the second control branch upon the failure of the control means of the first control branch such that the activated control means of the second branch drives the first servo control shaft or configured to activate the control means of the second control branch upon receiving a signal to activate the second control branch such that the control means of the first and second branches drive the first servo control shaft.

2. The system according to claim 1, wherein the control means of the first branch comprises a first shaft control node configured to drive the first servo control shaft, and the control means of the second branch comprises a first shaft control node configured to drive the first servo control shaft, the first shaft control node of the first branch and the first shaft control node of the second branch being connected to the selection means.

3. The system according to claim 2, wherein the control means of the first branch comprises at least one second shaft control node configured to drive a second servo control shaft, and the control means of the second branch comprises at least one second shaft control node configured to drive the second servo control shaft, the shaft control nodes of the first branch being connected to one another in series such that the second node of the first branch is connected to the first node of the first branch, and the shaft control nodes of the second branch being connected to one another in series such that the second node of the second branch is connected to the first node of the second branch.

4. The system according to claim 3, wherein that node from amongst the shaft control nodes of the first branch which is connected only to a single shaft control node of the first branch is connected to the corresponding shaft control node of the second branch.

5. The system according to claim 2, wherein the control means of the first branch comprises a second shaft control node configured to drive a second servo control shaft, and the control means of the second branch comprises a second shaft control node configured to drive the second servo control shaft, the second control node of the first branch and the second control node of the second branch being connected to the selection means.

6. The system according to claim 1, wherein the control means of the first branch comprises a position control node and a first amplification node which are configured to drive the first servo control shaft, and the control means of the second branch comprises a position control node and a first amplification node which are configured to drive the first servo control shaft, the first amplification node of the first branch being connected to the position control node of the first branch and the first amplification node of the second branch being connected to the position control node of the second branch, the position control node of the first branch and the position control node of the second branch being connected to the selection means.

7. The system according to claim 6, wherein the first branch comprises at least one second amplification node configured to drive a second servo control shaft, and the second branch comprises at least one second amplification node configured to drive the second servo control shaft, the amplification nodes of the first branch being connected to one another in series and the amplification nodes of the second branch being connected to one another in series.

8. The system according to claim 7, wherein that amplification node of the first branch which is connected only to a single amplification node of the first branch is furthermore connected to the position control node of the first branch, and that amplification node of the second branch which is connected only to a single amplification node of the second branch is furthermore connected to the position control node of the second branch.

9. The system according to claim 7, wherein that amplification node of the first branch which is connected only to a single amplification node of the first branch is furthermore connected to the corresponding amplification node of the second branch.

10. A method for controlling a magnetic bearing, the method comprising:
activating a control means of a second control branch upon the failure of a control means of a first control branch driving a first servo control shaft of the magnetic bearing such that the activated control means of the second branch drives the first servo control shaft of the magnetic bearing, the second control branch being identical to the first control branch; or
activating the control means of the second control branch upon receiving a signal to activate the second control branch such that the first and second branches drive the first servo control shaft of the magnetic bearing.
